(19) United States
(12) Patent Application Publication
(10) Pub. No.: US 2024/0126947 A1
(43) Pub. Date: Apr. 18, 2024

(54) STRENGTH AND STIFFNESS OPTIMIZATION OF COATED STRUCTURES WITH LATTICE INFILL

(71) Applicants: Ali Tamijani et al., Ormond Beach, FL (US); Zhichao Wang, Port Orange, FL (US)

(72) Inventors: Ali Tamijani et al., Ormond Beach, FL (US); Zhichao Wang, Port Orange, FL (US)

(21) Appl. No.: 18/480,746

(22) Filed: Oct. 4, 2023

Related U.S. Application Data
(60) Provisional application No. 63/378,645, filed on Oct. 6, 2022.

(51) Int. Cl. G06F 30/20; B29C 64/393; B33Y 50/02; G06F 30/17

(52) U.S. Cl. CPC G06F 30/20; B29C 64/393; B33Y 50/02; G06F 30/17; G06F 2111/10

(57) ABSTRACT

A machine-implemented method for establishing optimized parameters defining a model of a coated structure with a lattice infill can include receiving constraints for the model of the coated structure. The machine-implemented method can also include initializing a lattice infill defined by respective lattice cells according to the constraints for the model of the coated structure. The machine-implemented method can also include optimizing the lattice infill and a shape of the coated structure by iteratively modifying the lattice infill and the shape of the coated structure and evaluating a strength-based criterion. The machine-implemented method can also include generating, using the optimized lattice infill and the optimized shape of the coated structure with the lattice infill, a representation of the model of the coated structure with the lattice infill conforming to the constraints for the model of the coated structure.

### CLAIM OF PRIORITY

This patent application claims the benefit of priority, under 35 U.S.C. Section 219(e), to Ali Tamijani U.S. Patent Application Ser. No. 63/378,645, entitled “STRENGTH AND STIFFNESS ENHANCEMENT OF COATED STRUCTURES WITH LATTICE INFILL,” filed on October 6, 122, which is hereby incorporated by reference herein in its entirety.

### STATEMENT REGARDING FEDERALLY SPONSORED RESEARCH OR DEVELOPMENT

This invention was made with government support under award number 1847133 awarded by National Science Foundation (NSF). The government has certain rights in this invention.

### TECHNICAL FIELD

Examples described herein generally relate to optimizing structures and more specifically to strength and stiffness optimization of coated structures with lattice infill using a machine-implemented technique.

### BACKGROUND

Additive manufacturing (AM) enables the fabrication of high-performance parts with design freedom, such as a structures comprising a solid outer shell with a porous infill (coated structure). Use of structures fabricated using AM can provide an enhanced strength-to-weight ratio compared to traditional non-additive manufacturing techniques.

### SUMMARY

Machine-implemented methodologies can leverage AM's design flexibility to provide structural configurations that have improved performance. For instance, in one approach, a stiffness-based criterion can be used in machine-implemented optimization. Other constraints can be used, such as a strength-based criterion. According to the present subject matter, a machine-implemented method for establishing optimized parameters defining a model of a coated structure with a lattice infill, the machine-implemented method can include receiving one or more spatial boundary conditions defining constraints for the model of the coated structure, initializing a lattice infill defined by respective lattice cells according to the one or more spatial boundary conditions, optimizing the lattice infill and a shape of the coated structure by iteratively modifying the lattice infill and the shape of the coated structure and evaluating a strength-based criterion, and generating, using the optimized lattice infill and the optimized shape of the coated structure with the lattice infill, a representation of the model of the coated structure with the lattice infill conforming to the one or more spatial boundary conditions.

As another example, a machine-implemented method for establishing optimized parameters can include defining a model of a coated structure with a lattice infill, the machine-implemented method can include receiving constraints for the model of the coated structure, initializing a lattice infill defined by respective lattice cells according to the constraints for the model of the coated structure, optimizing the lattice infill and a shape of the coated structure by iteratively modifying the lattice infill and the shape of the coated structure and evaluating a strength-based criterion, and generating, using the optimized lattice infill and the optimized shape of the coated structure with the lattice infill, a representation of the model of the coated structure with the lattice infill conforming to the constraints for the model of the coated structure.

### BRIEF DESCRIPTION OF THE DRAWINGS

Various examples are illustrated in the figures of the accompanying drawings. Such examples are demonstrative and not intended to be exhaustive or exclusive examples of the present subject matter.

FIG. 1 illustrates a machine-implemented method for establishing optimized parameters defining a model of a coated structure with a lattice infill, the machine-implemented method in accordance with one embodiment of the present disclosure.

FIG. 2 illustrates an example showing characteristic parameters for a cubic lattice.

FIG. 3 illustrates an example showing characteristic parameters for an octet-truss lattice.

FIG. 4A illustrates a simplified diagram of an example involving a a material indicator variable.

FIG. 4B illustrates a simplified diagram of an example involving a coating thickness.

FIG. 4C illustrates a simplified diagram of an example involving a density distribution.

FIG. 5 illustrates an example of a design domain with an extended region.

FIG. 6A illustrates a simulated stress distribution of an example comprising a cubic lattice with fixed microstructure density compliance-based optimization.

FIG. 6B illustrates a simulated stress distribution of an illustrative example comprising a cubic lattice with varied microstructure density microstructure density compliance-based optimization.

FIG. 6C illustrates a simulated stress distribution of an illustrative example comprising cubic lattice with fixed microstructure density strength-based optimization.

FIG. 6D illustrates a simulated stress distribution of an illustrative example comprising cubic lattice with varied microstructure density microstructure density strength-based optimization.

FIG. 7A illustrates a simulated example of a coated structure comprising a projected cubic lattice with compliance-based optimization with a fixed characteristic parameter.

FIG. 7B illustrates a simulated example of a coated structure comprising a projected cubic lattice with compliance-based optimization with a varied characteristic parameter.

FIG. 7C illustrates a simulated example of a coated structure comprising a projected cubic lattice with strength-based optimization with a fixed characteristic parameter.

FIG. 7D illustrates a simulated example of a coated structure comprising a projected cubic lattice with strength-based optimization with a varied characteristic parameter.

FIG. 8A illustrates a simulated stress distribution of an illustrative example comprising octet-truss lattice with a fixed microstructure density compliance-based optimization.

FIG. 8B illustrates a simulated stress distribution of an illustrative example comprising octet-truss lattice with varied microstructure density microstructure density compliance-based optimization.

FIG. 8C illustrates a simulated stress distribution of an illustrative example comprising octet-truss lattice with fixed microstructure density strength-based optimization.

FIG. 8D illustrates a simulated stress distribution of an illustrative example comprising octet-truss lattice with varied microstructure density microstructure density strength-based optimization.

FIG. 9A illustrates a simulated example of a coated structure comprising a projected octet-truss lattice with compliance-based optimization with a fixed characteristic parameter.

FIG. 9B illustrates a simulated example of a coated structure comprising a projected octet-truss lattice with compliance-based optimization with a varied characteristic parameter.

FIG. 9C illustrates a simulated example of a coated structure comprising a projected octet-truss lattice with strength-based optimization with a fixed characteristic parameter.

FIG. 9D illustrates a simulated example of a coated structure comprising a projected octet-truss lattice with strength-based optimization with a varied characteristic parameter.

FIG. 10A illustrates an example of a coated structure comprising a projected cubic lattice without side coating.

FIG. 10B illustrates an example of a coated structure comprising a projected octet-truss lattice without side coating.

FIG. 11A illustrates an example of a perspective view of a simulated density distribution of an illustrative example of a coated structure.

FIG. 11B illustrates an example of a side view of a simulated density distribution of an illustrative example of a coated structure.

FIG. 11C illustrates a simulated stress distribution of a perspective view of an illustrative example of a coated structure.

FIG. 11D illustrates a simulated stress distribution of a side view of a density distribution of an illustrative example of a coated structure.

FIG. 11E illustrates a perspective view of an illustrative example of a coated structure comprising a lattice infill.

FIG. 11F illustrates a perspective view of an illustrative example of a projected lattice infill.

FIG. 12 illustrates a machine-implemented method for establishing optimized parameters defining a model of an example coated structure comprising a lattice infill.

FIG. 13 illustrates a block diagram illustrating an example of a machine upon which one or more examples may be implemented.

### DETAILED DESCRIPTION

Additive manufacturing can enable fabrication of structures having enhanced strength-to-weight ratios through as compared to traditional non-additive manufacturing methods. For example, compliance or stiffness-based optimization has improved strength-to-weight ratios of additively manufactured structures. The present disclosure utilizes both strength and stiffness optimization concurrently for coated structures with lattice infill to further enhance performance.

Coated structures with lattice infill can leverage design flexibility to improve strength and stiffness under volume constraints. The coating and infill distribution can be jointly optimized based on strength and stiffness constraints. Yield criteria, like a modified Hill's criterion, can establish stress limits within the optimization framework. The coating can converge to a solid shell in stress-constrained regions, reducing failure load compared to compliance (e.g., stiffness) based optimization alone.

Numerical homogenization can determine the effective properties of the microscopic periodic lattice infill. Infill patterns can include octet-truss, cubic, and other lattice units that can enhance strength and stiffness. Material and coating indicators can be used to represent a coated structure geometry. Indicators can be obtained via smoothing and projection of variables. Lattice geometry can be defined by characteristic parameters for each structure type. Holding parameters constant while varying indicators can produce uniform infill under constraints. Optimizing parameters as variables can enable non-uniform infill distribution.

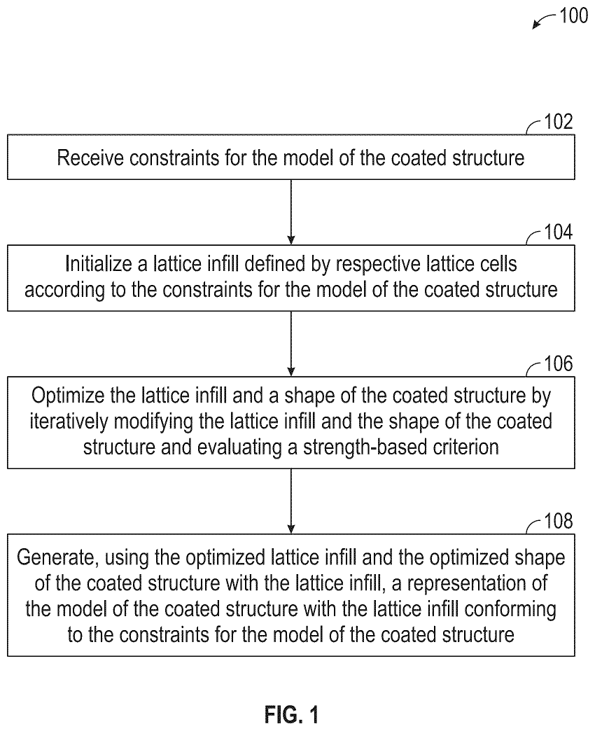

Examples herein obtained via numerical analysis show that strength-based optimization can produce smoother boundaries and lower failure loads than compliance-based optimization, alone. Additionally, considering both material and coating indicators during strength optimization further improves physical topology and infill material distribution as compared to using characteristic lattice parameters without more. Techniques for strength and stiffness optimization for coated structures with lattice infill will be discussed below with reference to FIGS. 1-13.

FIG. 1 illustrates a machine-implemented method 100 for establishing optimized parameters defining a model of a coated structure with a lattice infill. The machine-implemented method 100 can use both strength and stiffness-based optimization techniques to improve the structural performance of the design beyond what could be achieved through stiffness or compliance-based optimization alone. In examples, the strength-based criterion can correspond to one or more element failure indices that can quantify localized failure modes (e.g., yielding or buckling).

At operation 102, the machine-implemented method 100 can include receiving constraints for the model of the coated structure. The constraints can define the design space and can include limits on the total volume of material, specified locations for applied loads and boundary conditions, manufacturing capabilities, and material properties of the coating and lattice infill. Defining these constraints can help the model achieve a physically realizable optimized design. In examples, optimizing the lattice infill and coated structure shape can include assigning material indicator variables corresponding to the shape and coating indicator variables corresponding to the coating thickness. Assigning the material indicator variables and coating indicator variables can help facilitate geometry and dimension optimization of the design.

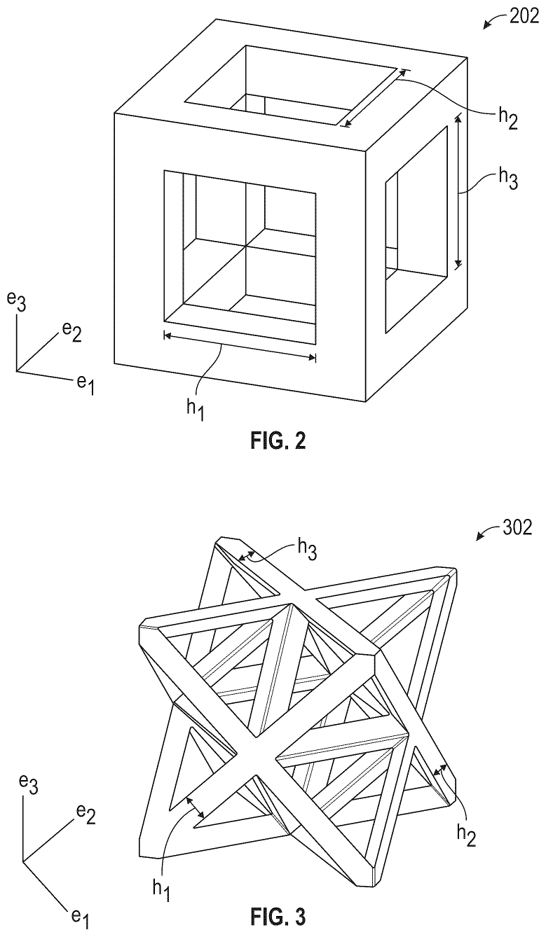

At operation 104, the machine-implemented method 100 can include initializing a lattice infill defined by respective lattice cells according to the constraints for the model of the coated structure. The lattice infill can include cubic cells (as discussed with reference to FIG. 2), octet-truss structures (as discussed with reference to FIG. 3), or other predefined patterns that can be additively manufactured. In examples, the lattice infill geometry can be represented by characteristic parameters, which can be determined for each design of the lattice infill (e.g., the cubic cell or octet-truss) with either uniform or varied densities. Candidate materials for the lattice structure include polymers, metals, and alloys. The combination of a solid coating and porous lattice infill provides both strength and stiffness to the optimized design.

At operation 106, the machine-implemented method 100 can include optimizing the lattice infill and shape of the coated structure by iteratively modifying the lattice and coating and evaluating a strength-based criterion. The lattice and coating can be co-optimized concurrently, or sequentially optimized in either order. In examples, the optimization process can include holding the lattice parameter constant while optimizing the coating shape or allowing the lattice parameter to vary to enable concurrent optimization. Moreover, the optimization process can include numerical homogenization to determine effective properties, apply yield criteria to define elastic limits, and aggregate element failure indices. The optimization of the lattice infill and the coating seeks to maximize strength-based metrics like buckling resistance and plastic collapse within the established constraints.

At operation 108, the machine-implemented method 100 can include generating a representation of the optimized coated structure with lattice infill conforming to the constraints. The representation can include a 2D or 3D CAD model (e.g., vector data), drawings representative of one or more projections, or other specifications to support fabrication or further analysis. The optimized structure can leverage the combined effect between the optimized coating and the optimized lattice infill.

FIGS. 2 and 3 will be discussed together. FIG. 2 illustrates an example of characteristic parameters for a cubic lattice 200. FIG. 3 illustrates an example of characteristic parameters for an octet-truss lattice 300.

An infill region (e.g., the cubic lattice 200 (FIG. 2) or the octet-truss lattice 300 (FIG. 3)) of coated structures can include periodic cells. Homogenized properties of such “micro lattices” can be used to define the topology optimization framework. As shown in FIG. 2, the characterizing parameters (h₁, h₂, h₃) for the cubic lattice 200 can be selected to establish the lattice geometry. The homogenized stiffness tensor (C̅(h₁, h₂, h₃)) and macroscopic effective yield stresses (σ̅^{Y}(h₁, h₂, h₃)) can be obtained using numerical homogenization. The infill density function ρ^{I}(h₁, h₂, h₃) can be calculated analytically for the cubic lattice 200 using (ρ̅(h₁, h₂, h₃)=(1−h₁h₂−h₁h₃−h₂h₃+2h₁h₂h₃)). The infill density function for the octet-truss lattice 300 can be found numerically. The infill density for the cubic lattice 200 and the octet-truss lattice 300 can be implemented into the constraint framework for each respective infill. The stiffness tensor (C⁰) and yield stresses (σ^{Y}) for the coating around the lattice infill (e.g., the cubic lattice 200 or the octet-truss lattice 300 can be obtained based on the material properties.

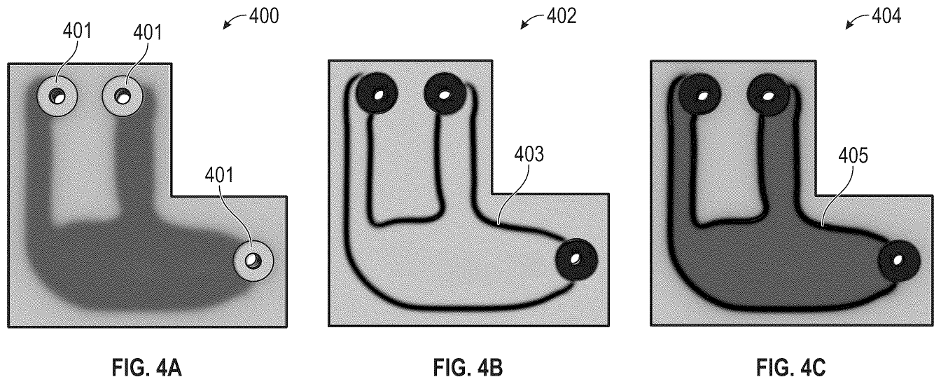

FIGS. 4A-4C will be discussed together. FIG. 4A illustrates a simplified diagram 400 of an example material indicator variable. FIG. 4B illustrates a simplified diagram 402 of an example coating thickness. FIG. 4C illustrates a simplified diagram 404 of an example density distribution.

To establish the coated structures a material indicator variable (φ) can be introduced to represent the base structure, as shown in the simplified diagram 400. As such, the points of influence 401 can be defined. Double smoothing and projection (DSP) of variable μ can be used to find the material indicator. For the DSP, the filter radius (R₁) and projection parameters β₁ and η₁ can be similar for both steps. Then, the coating thickness (τ) (e.g., coating thickness 403) can be obtained from the smoothing and projection of φ with filter radius (R₂, R₂<R₁) and projection parameters β₂ and η₂, as shown in the simplified diagram 402. In examples, R₂ can be related to a reference coating thickness (t_{ref}) by R₂≈2.5t_{ref}.

The smoothing and projection operations can be determined using the filtering projection operations, such as, for example, the Helmholtz-type filtering and smoothed Heaviside projection. The homogeneous Neumann boundary conditions in Helmholtz-type filtering equation can cause issues close to the boundary. Thus, a padding approach can be used to resolve the boundary issues caused by the Helmholtz-type filtering. The boundary of the design domain can be extended (dₑₓₜ) except at the support and load regions. The stiffness tensor can be multiplied by a parameter q to ensure the candidate parameters remain in the original design domain. In examples, q=0.1 can be used.

The stiffness tensor and density can be defined based on the coating and infill:

C(φ,τ,h₁,h₂,h₃)=10⁻⁹C⁰+q(C̅(h₁,h₂,h₃)−10⁻⁹C⁰)φ^{p}^{₁}+q(C⁰−C̅(h₁,h₂,h₃)φ^{p}^{₁})τ^{p}^{₂} (1)

ρ(φ,τ,h₁,h₂,h₃)=ρ̅(h₁,h₂,h₃)φ+(1−p̅(h₁,h₂,h₃)φ)τ (2)

where p₁ and p₂ are the penalty parameters related to the material indicator and coating thickness. The element failure index vector (γₑ) can be defined based on the Hill's yield criterion.

$${γ}_{e} = \sqrt{{σ}^{T} 𝕍 σ} \qquad ( 3 )$$

$${𝕍}_{11} = {( \frac{1}{{\overline{σ}}_{11}^{Y}} )}^{2} , {𝕍}_{22} = {( \frac{1}{{\overline{σ}}_{22}^{Y}} )}^{2} , {𝕍}_{22} = {( \frac{1}{{\overline{σ}}_{33}^{Y}} )}^{2}$$

$${𝕍}_{12} = - \frac{1}{2} ( {( \frac{1}{{\overline{σ}}_{11}^{Y}} )}^{2} + {( \frac{1}{{\overline{σ}}_{22}^{Y}} )}^{2} - {( \frac{1}{{\overline{σ}}_{33}^{Y}} )}^{2} ) ,$$

$${𝕍}_{13} = - \frac{1}{2} ( {( \frac{1}{{\overline{σ}}_{11}^{Y}} )}^{2} + {( \frac{1}{{\overline{σ}}_{33}^{Y}} )}^{2} - {( \frac{1}{{\overline{σ}}_{22}^{Y}} )}^{2} ) ,$$

$${𝕍}_{23} = - \frac{1}{2} ( {( \frac{1}{{\overline{σ}}_{22}^{Y}} )}^{2} + {( \frac{1}{{\overline{σ}}_{33}^{Y}} )}^{2} - {( \frac{1}{{\overline{σ}}_{11}^{Y}} )}^{2} )$$

For the coating region, the stress can be σ=C⁰ε and the yield stress can be σ̅^{Y}=σ^{Y}. For the infill region the stress can be σ=C̅ε, where ε is the macroscopic strain, and the effective yield stress can be, σ̅^{Y}, which can a function of characteristic parameters (h₁, h₂, h₃) (for each of the cubic lattice 200 or the octet-truss lattice 300, respectively). The ∈-relaxed approach can be adopted to address the stress singularities at low densities. The following stress interpolation function can be introduced for the coating and infill material distribution:

$${η}_{F} = \frac{φ}{ϵ ( 1 - φ ) + φ} + ( 1 - \frac{φ}{ϵ ( 1 - φ ) + φ} ) \frac{τ}{ϵ ( 1 - τ ) + τ} \qquad ( 4 )$$

where ∈=0.2 can be used in an example of the present disclosure. The relaxed failure index can then be introduced by utilizing the stress interpolation function:

γₑ^{r}=η_{F}γₑ (5)

and the element failure indices can be aggregated to a single function using the p-mean function:

$${γ}_{P} = {( ( \frac{1}{Ω} ) {\int }_{{Ω}_{m}} {( {γ}_{e}^{r} )}^{p} d Ω )}^{\frac{1}{p}} \qquad ( 6 )$$

where Ω is the volume of problem domain, p is a tuning coefficient. In examples, p=10 can be used.

Two optimization problems can be used, for example, minimizing the compliance or minimizing the p-mean failure function. For the minimizing the compliance option, J=∫_{Ω}ε^{T}(u)Cε(u)dx) can be subjected to the equilibrium equation and volume fraction constraint (g). For minimizing the p-mean failure function J=γₚ, can be subjected to the equilibrium equation and volume fraction constraint. Therefore, the following optimization statement can be used:

$$min J ( µ , {h}_{1} , {h}_{2} , {h}_{3} , u ) \qquad ( 7 )$$

$$subjected to \{ \begin{matrix}{\int }_{Ω} {ε}^{T} ( u ) C ε ( v ) dx = {\int }_{{Γ}_{N}} {f}^{T} v dx \\ g = ( \frac{1}{Ω} ) {\int }_{Ω} ρ ( µ , {h}_{1} , {h}_{2} , {h}_{3} , u ) d Ω - {V}_{g} \leq 0\end{matrix}$$

with design variables 0<hₙ and μ≤1. n=1, 2,3 where V_{g} can be the upper bound of the volume constraint, f can be tractions on boundary Γ_{N}, and v can be the virtual displacement field. An alternative strength-based optimization problem can be formulated based on minimizing the volume fraction subjected to failure constraint:

$$min ( \frac{1}{Ω} ) {\int }_{Ω} ρ ( µ , {h}_{1} , {h}_{2} , {h}_{3} , u ) d Ω \qquad ( 8 )$$

$$subjected to \{ \begin{matrix}{\int }_{Ω} {ε}^{T} ( u ) C ε ( v ) dx = {\int }_{{Γ}_{N}} {f}^{T} v dx \\ g = {γ}_{p} - 1 \leq 0\end{matrix}$$

with design variables 0<hₙ and μ≤1. n=1, 2,3.

The sensitivity analyses for volume fraction constraint, the compliance objective function, and the p-mean failure objective function can be performed in an optimization process. The sensitivity of the volume fraction is:

$$\frac{d g}{d {μ}_{e}} = ( \frac{1}{Ω} ) \frac{d {ρ}_{e}}{d {μ}_{e}} {Ω}_{e} \qquad ( 9 )$$

$$\frac{d g}{d {h}_{ne}} = ( \frac{1}{Ω} ) \frac{d {ρ}_{e}}{d {h}_{ne}} {Ω}_{e}$$

The adjoint method can be utilized to obtain the sensitivity of objective functions. The compliance objective function can be self-adjoint, thus:

$$\frac{\partial J}{\partial {μ}_{e}} = - {\int }_{{Ω}_{e}} {ε}^{T} ( u ) \frac{{dC}_{e}}{d {μ}_{e}} ε ( u ) d {Ω}_{e} \qquad ( 10 )$$

$$\frac{\partial J}{\partial {h}_{ne}} = - {\int }_{{Ω}_{e}} {ε}^{T} ( u ) \frac{{dC}_{e}}{d {h}_{ne}} ε ( u ) d {Ω}_{e}$$

For the stress objective function, the Lagrangian is constructed to find the adjoint equation and perform sensitivity. The Lagrangian for the p-mean failure objective function can be:

L=γₚ+∫_{Ω}ε^{T}(u)Cε(v)dx−∫_{Γ}_{_{N}}f^{T}vdΓ (11)

Then, the derivative of the Lagrangian with respect to μₑ can be:

$$\frac{d L}{d {μ}_{e}} = ( \frac{1}{Ω} ) {\int }_{{Ω}_{e}} {{γ}_{p}^{1 - p} ( {γ}_{e}^{r} )}^{p - 1} ( \frac{d {η}_{F}}{d {μ}_{e}} {γ}_{e} + {η}_{F} \frac{1}{{γ}_{e}} {σ}^{T} 𝕍 \overline{C} ε ( {u}^{′} ) ) d {Ω}_{e} + {\int }_{{Ω}_{e}} {ε}^{T} ( u ) \frac{{dC}_{e}}{d {μ}_{e}} ε ( v ) d {Ω}_{e} + {\int }_{Ω} {ε}^{T} ( {u}^{′} ) C ε ( v ) d Ω + {\int }_{Ω} {ε}^{T} ( u ) C ε ( {v}^{′} ) d Ω - {\int }_{{Γ}_{N}} {f}^{T} {v}^{′} d Γ \qquad ( 9 )$$

Imposing the equilibrium equation, and collecting the terms including u′ can result in adjoint equation:

$$( \frac{1}{Ω} ) {\int }_{Ω} {{γ}_{p}^{1 - p} ( {γ}_{e}^{r} )}^{p - 1} {η}_{F} \frac{1}{{γ}_{e}} {σ}^{T} 𝕍 \overline{C} ε ( {u}^{′} ) d Ω + {\int }_{Ω} {ε}^{T} ( {u}^{′} ) C ε ( v ) d Ω = 0 \qquad ( 10 )$$

After finding the adjoint variable v from the equation above, the sensitivity of the p-mean failure objective function can be obtained:

$$\frac{dJ}{d {μ}_{e}} = \frac{d L}{d {μ}_{e}} = ( \frac{1}{Ω} ) {\int }_{{Ω}_{e}} {{γ}_{p}^{1 - p} ( {γ}_{e}^{r} )}^{p - 1} \frac{d {η}_{F}}{d {μ}_{e}} {γ}_{e} d {Ω}_{e} + {\int }_{{Ω}_{e}} {ε}^{T} ( u ) \frac{{dC}_{e}}{d {μ}_{e}} ε ( v ) d {Ω}_{e} \qquad ( 11 )$$

The sensitivity of the p-mean failure objective function with respect to hₙₑ can be obtained by following the same procedure:

$$\frac{d J}{d {h}_{ne}} = ( \frac{1}{Ω} ) {\int }_{{Ω}_{e}} {{γ}_{p}^{1 - p} ( {γ}_{e}^{r} )}^{p - 1} {η}_{F} \frac{1}{{γ}_{e}} ( {σ}^{T} 𝕍 \frac{d \overline{C}}{d {h}_{ne}} ε ( v ) + {σ}^{T} \frac{d 𝕍}{d {h}_{ne}} σ ) d {Ω}_{e} + {\int }_{{Ω}_{e}} {ε}^{T} ( u ) \frac{{dC}_{e}}{d {h}_{ne}} ε ( v ) d {Ω}_{e} \qquad ( 12 )$$

Thus, as shown in simplified diagram 404, the density 405 of the lattice core can be found and the thickness properties, as also shown in the simplified diagram 402 can be used to for optimization problems. The optimization problems can be solved using a method of moving asymptotes. In examples, the analysis and optimization frameworks can be developed using the open-source partial differential equation (PDE) solver FreeFem++. The displacements and adjoint variables can be discretized using P₁-functions. All other variables, such as characteristic parameters, material indicator, and coating thickness can be discretized using P₀-functions.

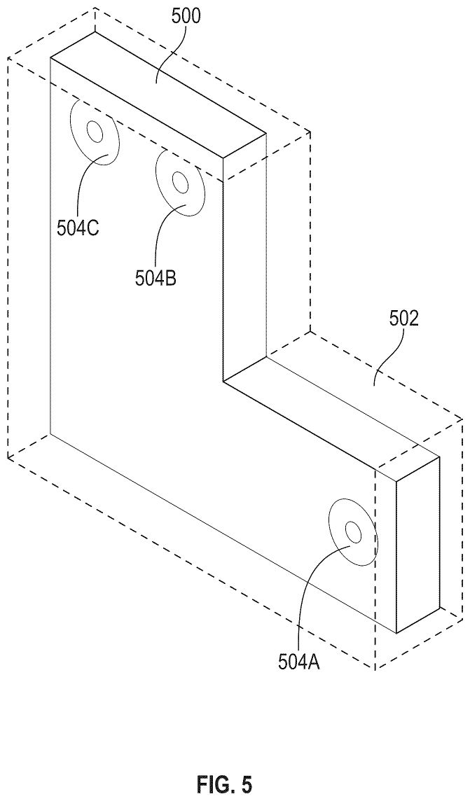

FIG. 5 illustrates an example of a design domain 500 including an extended region 502. The design domain 500 is used throughout the application as an example design in which the strength and stiffness optimization of coated structures with lattice infill can be applied. As shown in FIG. 5, the design domain 500 can include a 3D L-bracket with holes. The holes can be used to apply loading and the 3D I-bracket can include boundary conditions.

The design domain 500 can include three holes (504A-C). A downward pressure can be applied on the surface of the bottom hole 504A and the two top holes 504B and 504C, respectively, can be clamped or otherwise fixed. For examples, the volume fraction can be set to 30%, which is represented by the extended region 502.

The design domain 500 and the extended region 502 can be discretized by tetrahedral elements. For example, the design domain 500 and the extended region 502 can be discretized by three million or more tetrahedral elements, such as, for example 3.6 million tetrahedral elements. In examples, the material of the design domain 500 can include a Young's modulus of 1288.3 and the Poisson ratio is 0.475, which are both relative to the material that the design domain 500 is made from. Similarly, the optimization for the design domain 500 can include a yield strength σ^{Y} is 18.3 and a P-mean parameter is p=10.

These are sample limits and parameters that were used to showcase the success of the strength and stiffness optimization of coated structures with lattice infill as compared to other optimization systems. The inventors of the present application recognize that other limits or parameters can be used to obtain similar results.

For example, two sets of strength-based constraints with fixed and varied microstructure density can be evaluated for cubic and octet-truss lattices. The compliance designs can also be obtained to demonstrate an improvement of Hill's stress distribution by performing evaluation using a strength-based constraint. In such examples, a maximum count of iterations can be 900, 1000, 1100, 1200, or more. The optimized designs can be obtained using the HB120rs v2 virtual machine of Microsoft Azure that features 220 AMD EPYC 7002-series CPU cores, 580 GB of RAM and 580 MB of L3 cache. The strength-based constraint evaluation can be completed using varied and fixed microstructure densities.

For the cubic lattice (e.g., the cubic lattice 200 (FIG. 2)), the first filtering radius R₁ can be 1.25, the second filtering radius R₂ can be 0.5 and the reference coating thickness (t_{ref}) can be 0.2. The thickness of the extended region (e.g., the extended region 502 (FIG. 5)) can be dₑₓₜ=R₁. The lower and upper limits for the varied microstructure density can be set at 0.316 and 0.996, respectively. Thus, the range of characteristic parameters (hᵢ) can be between 0.2 and 0.7. For examples with fixed microstructure density, the characteristic parameters can be represented by hᵢ=0.5.

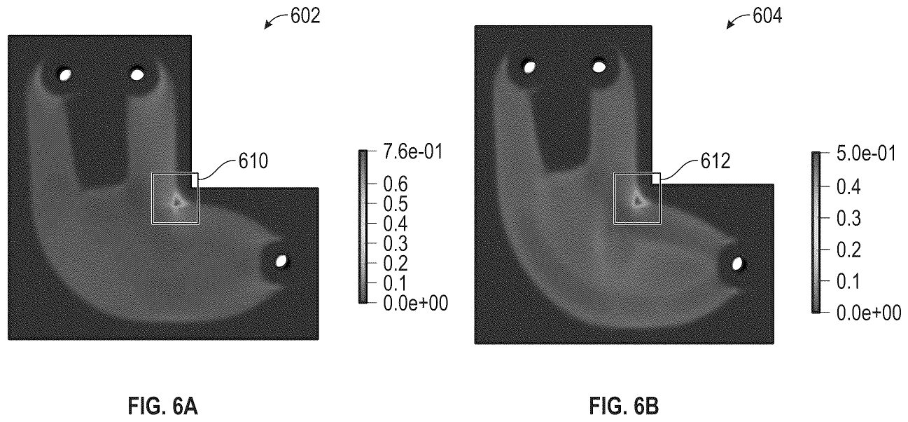

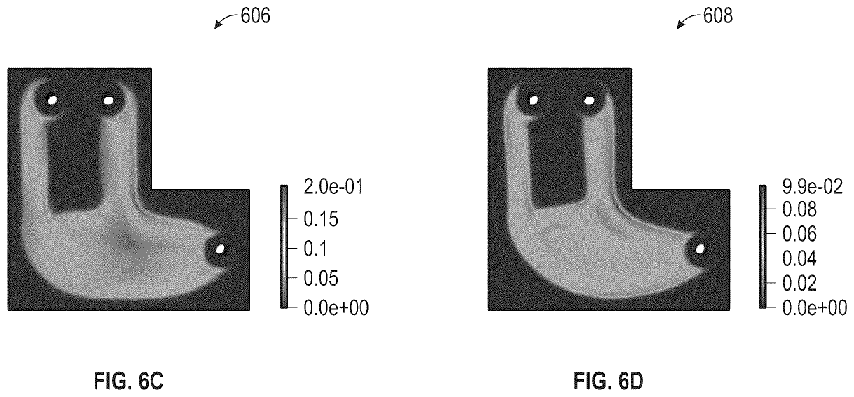

FIGS. 6A-6D will be discussed together. FIG. 6A illustrates an example stress distribution of an example cubic lattice structure 602 with fixed microstructure density compliance-based optimization. FIG. 6B illustrates an example stress distribution of an example cubic lattice structure 604 with varied microstructure density microstructure density compliance-based optimization. FIG. 6C illustrates an example stress distribution of an example cubic lattice structure 606 with fixed microstructure density strength-based optimization. FIG. 6D illustrates an example stress distribution of an example cubic lattice structure 608 with varied microstructure density microstructure density strength-based optimization.

The stress distribution shown in FIGS. 6A-6D can be, for example, a Hill's stress distribution. Each of the compliance-based optimizations (shown in FIGS. 6A and 6B) and the strength-based optimizations (shown in 6C and 6D) show that varying the density of the cubic lattice structure can result in lower compliance and Hill's stress. However, as shown in FIGS. 6A and 6B, the compliance-based designs (e.g., the cubic lattice structure 602 and the cubic lattice structure 604) include stress concentrations 610 and 612, respectively. However, as shown in FIGS. 6C and 6D, the stress concentrations (610 and 612) are no longer present when using the strength-based optimization regardless of whether the microstructure density is fixed (FIG. 6C) or varied (FIG. 6D). The optimizations shown in FIGS. 6C and 6D can have a lower maximum Hill's stress when compared to the optimizations shown in FIGS. 6A and 6B, respectively. Therefore, the strength-based optimizations can handle more load before reaching a failure point than the compliance-based optimizations.

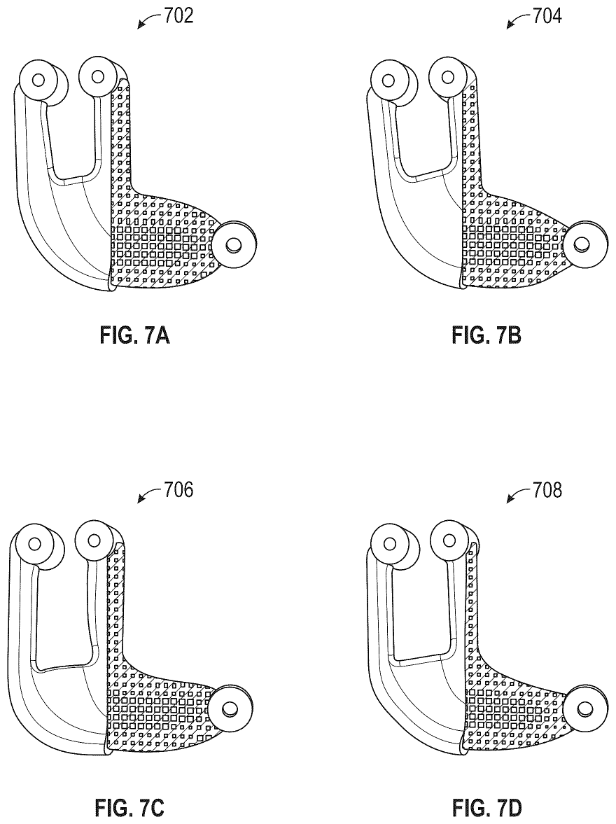

FIGS. 7A-7D will be discussed together. FIG. 7A illustrates an example of a coated structure with a projected cubic lattice 702 with compliance-based optimization with a fixed characteristic parameter. FIG. 7B illustrates an example of a coated structure with a projected cubic lattice 704 with compliance-based optimization with a varied characteristic parameter. FIG. 7C illustrates an example of a coated structure with a projected cubic lattice with strength-based optimization 706 with a fixed characteristic parameter. FIG. 7D illustrates an example of a coated structure with a projected cubic lattice 708 with strength-based optimization with a varied characteristic parameter.

For the examples shown in FIGS. 7A-7D, the projected cubic lattices for the compliance-based (7A and 7B) and strength-based designs (7C and 7D) can have a periodicity parameter of 0.5. After the periodicity parameter of the lattice structure is set, the lattice can be projected. Further analysis can be used to improve the manufacturability of the projected lattice. Such further analysis can be performed in multiple steps based on the minimum manufacturable feature size. First, a lattice can be created based on manufacturable thickness, and then regions can be created from the complement of the union between this lattice and the projected shape. Lastly, the regions with inscribed circle diameters (a measurement of porosity) less than manufacturable thickness can be filled.

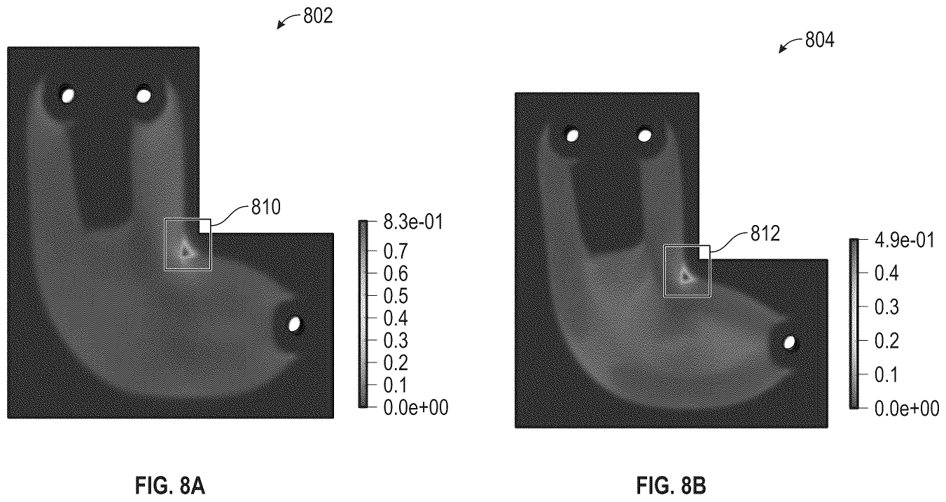

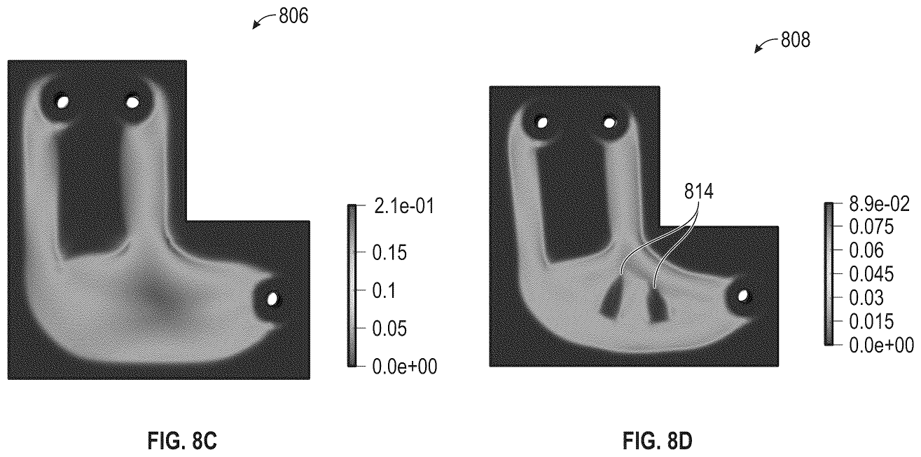

FIGS. 8A-8D will be discussed together. FIG. 8A illustrates an example stress distribution of an example octet-truss lattice structure 802 with a fixed microstructure density compliance-based optimization. FIG. 8B illustrates an example stress distribution of an example octet-truss lattice structure 804 with varied microstructure density microstructure density compliance-based optimization. FIG. 8C illustrates an example stress distribution of an example octet-truss lattice structure 806 with fixed microstructure density strength-based optimization. FIG. 8D illustrates an example stress distribution of an example octet-truss lattice structure 808 with varied microstructure density microstructure density strength-based optimization.

For the octet-truss lattice, the range of hᵢ for the varied microstructure density problem can be set between 0.15 and 0.65. For the fixed microstructure density problem, hᵢ can be set at 0.33 to achieve the same density as the cubic lattice. The octet-truss lattice properties can be closer to a sphere for intermediate densities than those of the cubic lattice. Therefore, the first filtering R₁ for the octet-truss fixed microstructure density can be slightly increased (R₁=1.5) to prevent the design from converging into a SIMP solid-void design.

As shown in FIGS. 8A and 8B, the compliance-based optimization of the octet-truss lattice results in stress concentrations 810 and 812, respectively, and as shown in FIGS. 8C and 8D, those stress concentrations (810 and 812) are attenuated in the strength-based optimization. The strength-based optimization with the varied microstructure density shown by the example octet-truss lattice structure 808 shows that varying the microstructure density can result in perforations 814. The perforations result in less material, which can reduce cost and weight of the design as compared to the other designs (e.g., the octet-truss lattice structure 802, the octet-truss lattice structure 804, and the octet-truss lattice structure 806), while still maintaining a greater strength than non-strength-based optimizations designs (e.g., the octet-truss lattice structure 802 and the octet-truss lattice structure 804).

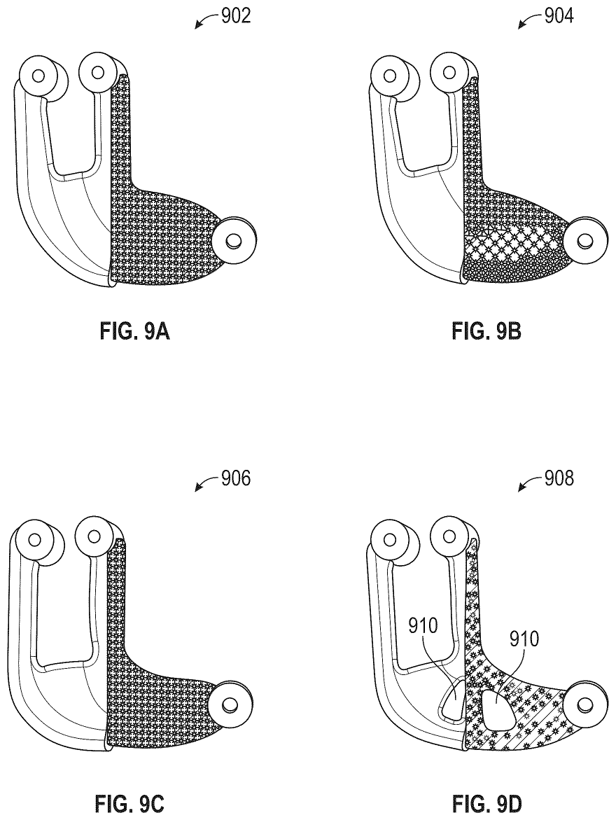

FIGS. 9A-9D will be discussed together. FIG. 9A illustrates an example of a coated structure with a projected octet-truss lattice 902 with compliance-based optimization with a fixed characteristic parameter. FIG. 9B illustrates an example of a coated structure with a projected octet-truss lattice 904 with compliance-based optimization with a varied characteristic parameter. FIG. 9C illustrates an example of a coated structure with a projected octet-truss lattice 906 with strength-based optimization with a fixed characteristic parameter. FIG. 9D illustrates an example of a coated structure with a projected octet-truss lattice 908 with strength-based optimization with a varied characteristic parameter.

Because the octet-truss lattice (e.g., the octet-truss lattice 300 (FIG. 3)) provides weaker orthotropic properties compared to cubic lattice (e.g., the cubic lattice 200 (FIG. 2)), the strength-based constraint infill density distribution (e.g., the projected octet-truss lattice 908) can be more like a SIMP approach. The cubic lattice (e.g., the cubic lattice 200 (FIG. 2) can be more sensitive to the orientation of the structure due to the orthotropic properties of the cubic lattice at intermediate densities. However, because the orientation is fixed in these examples, the failure index γₚ, maximum Hill's stress, and compliance are lower for the octet-truss lattice. The fixed microstructure density case of the octet-truss can yield slightly higher optimized results than the cubic lattice due to utilizing a larger filtering parameter. As shown in FIG. 9D, as the density of the microstructure is allowed to vary, the projected octet-truss lattice 908 can include perforations 910. The perforations 910 decrease material usage, which can reduce weight and cost, while maintaining the structural integrity of the design.

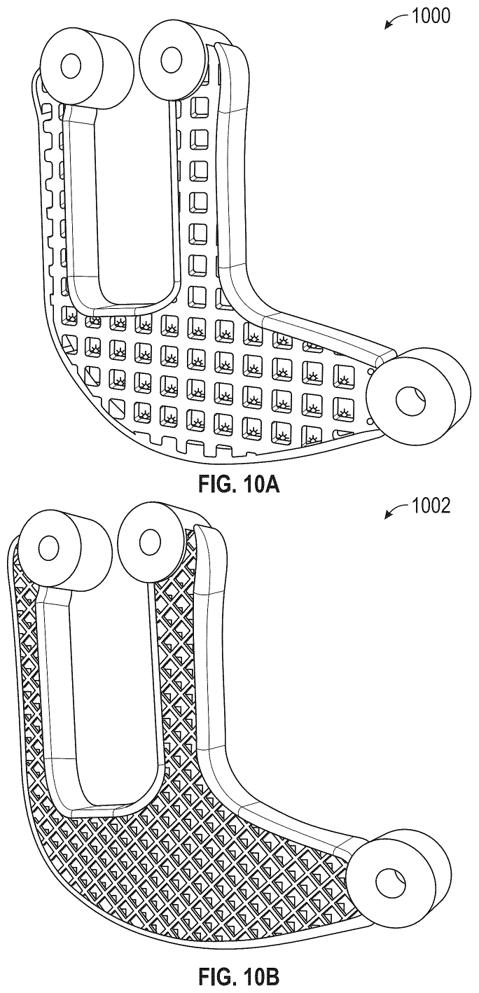

FIGS. 10A and 10B will be discussed together. FIG. 10A illustrates an example of a coated structure 1000 with a projected cubic lattice without side coating. FIG. 10B illustrates an example of a coated structure 1002 with a projected octet-truss lattice without side coating.

During some additive manufacturing procedures (e.g., selective laser sintering (SLS) or direct metal laser sintering (DMLS) power can become entrapped within the component or part being built. One approach to address this issue is to remove the extended region on the two sides in the x-y plan. Because the coated structure 1000 and the coated structure 1002 do not have sides, it can be easier to remove powder, debris, or other additive manufacturing byproducts from the structures. However, the octet-truss (e.g., coated structure 1002) and cubic lattice (e.g., coated structure 1000) designs without the side coating can have a lower out-of-plane bending stiffness compared to the optimized designs having coating on the sides of the lattice infill structure. Therefore, if out-of-plane stiffness is a constraint, instead of removing entire sides of the structure as shown in the coated structure 1000 and the coated structure 1002, holes can be inserted in the coating to help with removal of the powder.

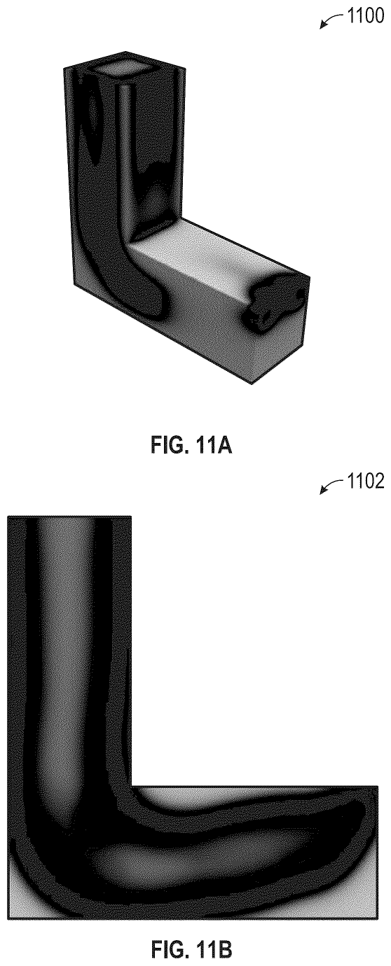

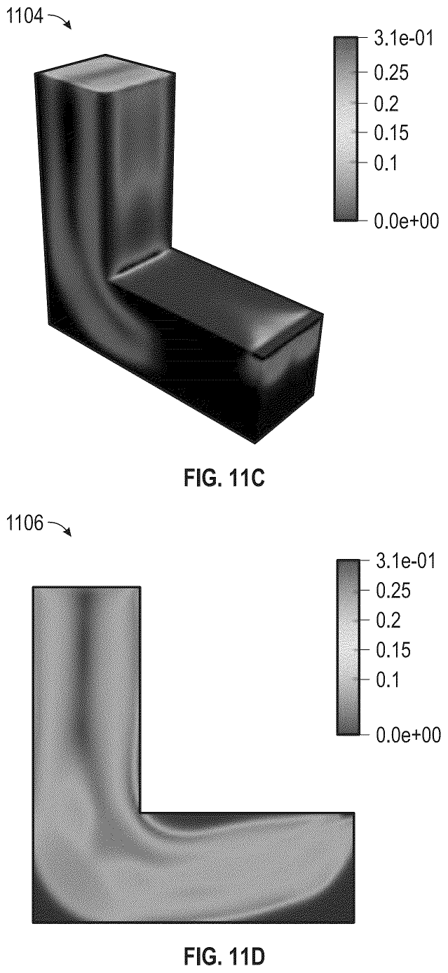

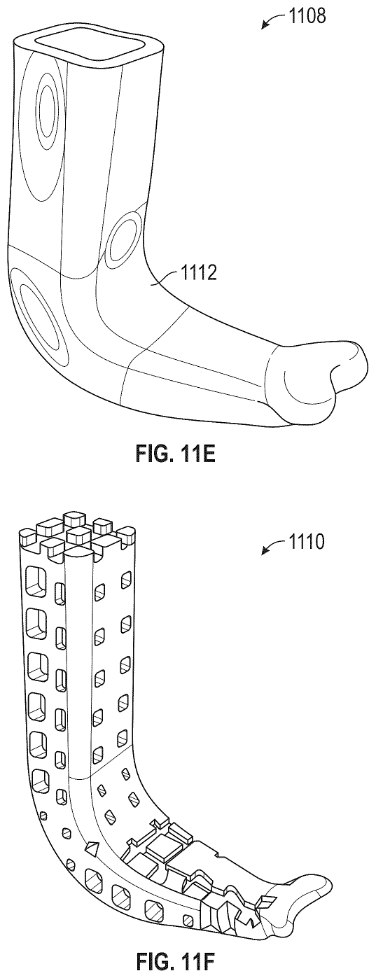

FIGS. 11A-11F illustrate density and stress distributions for an optimized coated structure with lattice infill using concurrent strength and stiffness constraints.

Compared to stiffness-only optimization, concurrently optimizing for strength and stiffness produces higher infill density in both the z-y and x-y planes, as shown in the top-down and side views of the density distribution (FIGS. 11A and 11B). The stress distribution (FIG. 11C) resembles stiffness-only optimization. However, the extended region and coating thickness optimization specific to the strength-based approach enable a smoother lattice boundary curve at the corner (FIG. 11E). This reduces stress concentrations compared to stiffness-only designs (FIGS. 6 and 8). The combined strength and stiffness optimization achieves lower Hill's stress (0.31 vs 0.1089 for stiffness-only), attributed to the extended region, coating thickness, finer mesh, different objectives/constraints, and modified shape from the material indicator. FIG. 11F shows the final projected lattice infill design using 5 mm periodicity.

In summary, the concurrent strength and stiffness optimization produces higher infill densities, smoother boundaries, lower stresses, and an overall improved design compared to stiffness-only optimization. The extended region, coating thickness, fine mesh, modified objectives, and material indicator help enable these benefits in the strength-based approach.

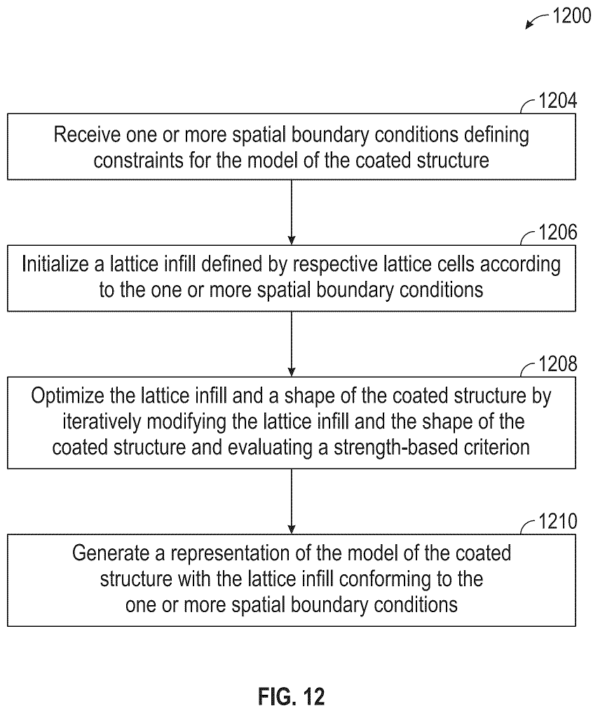

FIG. 12 illustrates a machine-implemented method 1200 for establishing optimized parameters defining a model of a coated structure with a lattice infill, the machine-implemented method in accordance with one embodiment. The machine-implemented method 1200 can be carried out by a computer system having one or more processors and non-transitory computer-readable storage media storing instructions executable by the one or more processors. The coated structure can include a structural component with an outer coating and an internal lattice infill structure. The lattice infill structure can include an interconnected network of struts or beams forming a predefined pattern of cells within the interior volume of the structural component.

In operation 1202, the machine-implemented method 1200 receives one or more spatial boundary conditions defining constraints for the model of the coated structure. The spatial boundary conditions can specify the overall shape and dimensions of the coated structure, locations where forces and loads are applied, interface regions where the structure connects to other components, manufacturing constraints, etc. The spatial boundary conditions establish the design space within which the lattice infill structure and overall shape of the coated structure can be optimized.

In operation 1204, the machine-implemented method 1200 initializes a lattice infill defined by respective lattice cells according to the one or more spatial boundary conditions. Initializing the lattice infill can include generating an initial lattice configuration that conforms to the spatial boundary conditions. For example, the initial lattice configuration can include a regular pattern of cubic cells that fills the interior volume of the structural component. The initial lattice configuration provides a starting point for the optimization process.

In operation 1206, the machine-implemented method 1200 optimizes the lattice infill and a shape of the coated structure by iteratively modifying the lattice infill and the shape of the coated structure and evaluating a strength-based criterion. The strength-based criterion can include structural stiffness, buckling resistance, strength-to-weight ratio, or other measures of structural performance. The lattice infill and overall shape are iteratively updated to maximize the strength-based criterion within the design space defined by the spatial boundary conditions. Optimization algorithms such as topology optimization, generative design, and gradient-based methods can be utilized.

In operation 1208, the machine-implemented method 1200 generates, using the optimized lattice infill and the optimized shape of the coated structure with the lattice infill, a representation of the model of the coated structure with the lattice infill conforming to the one or more spatial boundary conditions. The representation can include a 3D model, 2D drawings, renderings, or other documentation describing the optimized coated structure with lattice infill. The representation can be used for manufacturing, analysis, or other applications.

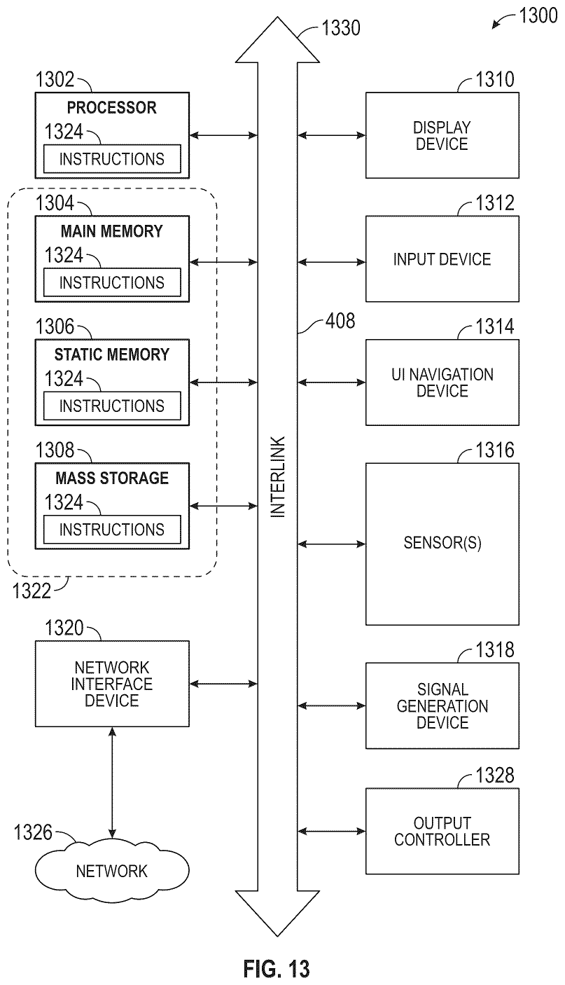

FIG. 13 illustrates a block diagram of an example machine 1300 upon which any one or more of the techniques (e.g., methodologies) discussed herein may perform. Examples, as described herein, may include, or may operate by, logic or a number of components, or mechanisms in the machine 1300. Circuitry (e.g., processing circuitry) is a collection of circuits implemented in tangible entities of the machine 1300 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1300 follow.

In alternative examples, the machine 1300 may operate as a standalone device or may be connected (e.g., networked) to other machines. In a networked deployment, the machine 1300 may operate in the capacity of a server machine, a client machine, or both in server-client network environments. In an example, the machine 1300 may act as a peer machine in peer-to-peer (P2P) (or other distributed) network environment. The machine 1300 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 1300 may include a hardware processor 1302 (e.g., a central processing unit (CPU), a graphics processing unit (GPU), a hardware processor core, or any combination thereof), a main memory 1304, a static memory (e.g., memory or storage for firmware, microcode, a basic-input-output (BIOS), unified extensible firmware interface (UEFI), etc.) 1306, and mass storage 1308 (e.g., hard drives, tape drives, flash storage, or other block devices) some or all of which may communicate with each other via an interlink (e.g., bus) 1330. The machine 1300 may further include a display unit 1310, an alphanumeric input device 1312 (e.g., a keyboard), and a user interface (UI) navigation device 1314 (e.g., a mouse). In an example, the display unit 1310, input device 1312 and UI navigation device 1314 may be a touch screen display. The machine 1300 may additionally include a storage device (e.g., drive unit) 1308, a signal generation device 1318 (e.g., a speaker), a network interface device 1320, and one or more sensors 1316, such as a global positioning system (GPS) sensor, compass, accelerometer, or other sensor. The machine 1300 may include an output controller 1328, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1302, the main memory 1304, the static memory 1306, or the mass storage 1308 may be, or include, a machine readable medium 1322 on which is stored one or more sets of data structures or instructions 1324 (e.g., software) embodying or utilized by any one or more of the techniques or functions described herein. The instructions 1324 may also reside, completely or at least partially, within any of registers of the processor 1302, the main memory 1304, the static memory 1306, or the mass storage 1308 during execution thereof by the machine 1300. In an example, one or any combination of the hardware processor 1302, the main memory 1304, the static memory 1306, or the mass storage 1308 may constitute the machine readable media 1322. While the machine readable medium 1322 is illustrated as a single medium, the term “machine readable medium” may include a single medium or multiple media (e.g., a centralized or distributed database, and/or associated caches and servers) configured to store the one or more instructions 1324.

The term “machine readable medium” may include any medium that is capable of storing, encoding, or carrying instructions for execution by the machine 1300 and that cause the machine 1300 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 1322 may be representative of the instructions 1324, such as instructions 1324 themselves or a format from which the instructions 1324 may be derived. This format from which the instructions 1324 may be derived may include source code, encoded instructions (e.g., in compressed or encrypted form), packaged instructions (e.g., split into multiple packages), or the like. The information representative of the instructions 1324 in the machine readable medium 1322 may be processed by processing circuitry into the instructions to implement any of the operations discussed herein. For example, deriving the instructions 1324 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 1324.

In an example, the derivation of the instructions 1324 may include assembly, compilation, or interpretation of the information (e.g., by the processing circuitry) to create the instructions 1324 from some intermediate or preprocessed format provided by the machine readable medium 1322. The information, when provided in multiple parts, may be combined, unpacked, and modified to create the instructions 1324. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 1324 may be further transmitted or received over a communications network 1326 using a transmission medium via the network interface device 1320 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 602.11 family of standards known as Wi-Fi®, IEEE 602.15.4 family of standards, peer-to-peer (P2P) networks, among others. In an example, the network interface device 1320 may include one or more physical jacks (e.g., Ethernet, coaxial, or phone jacks) or one or more antennas to connect to the communications network 1326. In an example, the network interface device 1320 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1300, and includes digital or analog communications signals or other intangible medium to facilitate communication of such software. A transmission medium is a machine-readable medium.

The following, non-limiting examples, detail certain aspects of the present subject matter to solve the challenges and provide the benefits discussed herein, among others.

Example 1 is a machine-implemented method for establishing optimized parameters defining a model of a coated structure with a lattice infill, the machine-implemented method comprising: receiving one or more spatial boundary conditions defining constraints for the model of the coated structure; initializing a lattice infill defined by respective lattice cells according to the one or more spatial boundary conditions; optimizing the lattice infill and a shape of the coated structure by iteratively modifying the lattice infill and the shape of the coated structure and evaluating a strength-based criterion; and generating, using the optimized lattice infill and the optimized shape of the coated structure with the lattice infill, a representation of the model of the coated structure with the lattice infill conforming to the one or more spatial boundary conditions.

In Example 2, the subject matter of Example 1 optionally includes wherein the strength-based criterion corresponds to one or more element failure indices.

In Example 3, the subject matter of any one or more of Examples 1-2 optionally include wherein optimizing the lattice infill and the shape of the coated structure comprises: assigning a material indicator variable corresponding to the shape; and assigning a coating indicator variable corresponding to at least a coating thickness.

In Example 4, the subject matter of any one or more of Examples 1-3 optionally include wherein at least one of initializing the lattice infill or optimizing the lattice infill comprises representing a geometry of the lattice infill with a characteristic parameter.

In Example 5, the subject matter of Example 4 optionally includes wherein optimizing the lattice infill and a shape of the coated structure comprises: establishing a held characteristic parameter by holding constant the characteristic parameter based on the geometry of the lattice infill; and establishing, using the held characteristic parameter, an optimized topology of the coated structure with uniform material distribution in the lattice infill.

In Example 6, the subject matter of any one or more of Examples 4-5 optionally include wherein optimizing the lattice infill and a shape of the coated structure comprises: assigning the characteristic parameter as a variable; and establishing, using the variable, a non-uniform material distribution of the lattice infill.

In Example 7, the subject matter of any one or more of Examples 4-6 optionally include creating an optimized shape of the coated structure with the lattice infill comprises: determining, using numerical homogenization, a stiffness tensor corresponding to the characteristic parameter; and determining, using numerical homogenization, a macroscopic effective yield stress corresponding to the characteristic parameter.

In Example 8, the subject matter of any one or more of Examples 1-7 optionally include wherein the strength-based parameter corresponds to a yield criterion to define a limit of elasticity of the model of the coated structure with the lattice infill.

In Example 9, the subject matter of any one or more of Examples 1-8 optionally include wherein the strength-based criterion comprises multiple element failure indices; and wherein the machine-implemented method comprises aggregating, using a p-mean approach, the multiple element failure indices to obtain an aggregated element failure index.

In Example 10, the subject matter of any one or more of Examples 1-9 optionally include wherein the lattice infill comprises octet-truss lattice cells.

In Example 11, the subject matter of Example 10 optionally includes wherein respective octet-truss lattice cells include a varied microstructure density.

In Example 12, the subject matter of any one or more of Examples 1-11 optionally include wherein the lattice infill comprises cubic lattice cells.

In Example 13, the subject matter of Example 12 optionally includes wherein respective cubic lattice cells include a varied microstructure density.

Example 14 is a machine-implemented method for establishing optimized parameters defining a model of a coated structure with a lattice infill, the machine-implemented method comprising: receiving constraints for the model of the coated structure; initializing a lattice infill defined by respective lattice cells according to the constraints for the model of the coated structure; optimizing the lattice infill and a shape of the coated structure by iteratively modifying the lattice infill and the shape of the coated structure and evaluating a strength-based criterion; and generating, using the optimized lattice infill and the optimized shape of the coated structure with the lattice infill, a representation of the model of the coated structure with the lattice infill conforming to the constraints for the model of the coated structure.

In Example 15, the subject matter of Example 14 optionally includes wherein optimizing the lattice infill and the shape of the coated structure comprises: assigning a material indicator variable corresponding to the shape; and assigning a coating indicator variable corresponding to at least a coating thickness.

In Example 16, the subject matter of any one or more of Examples 14-15 optionally include wherein the strength-based criterion corresponds to one or more element failure indices, and wherein at least one of initializing the lattice infill or optimizing the lattice infill comprises representing a geometry of the lattice infill with a characteristic parameter.

In Example 17, the subject matter of Example 16 optionally includes wherein optimizing the lattice infill and a shape of the coated structure comprises: establishing a held characteristic parameter by holding constant the characteristic parameter based on the geometry of the lattice infill; and establishing, using the held characteristic parameter, an optimized topology of the coated structure with uniform material distribution in the lattice infill.

In Example 18, the subject matter of any one or more of Examples 16-17 optionally include wherein optimizing the lattice infill and a shape of the coated structure comprises: assigning the characteristic parameter as a variable; and establishing, using the variable, a non-uniform material distribution of the lattice infill.

In Example 19, the subject matter of any one or more of Examples 16-18 optionally include creating an optimized shape of the coated structure with the lattice infill comprises: obtaining, using numerical homogenization, a stiffness tensor corresponding to the characteristic parameter; and obtaining, using numerical homogenization, a macroscopic effective yield stress corresponding to the characteristic parameter.

In Example 20, the subject matter of any one or more of Examples 14-19 optionally include wherein the strength-based criterion comprises multiple element failure indices; and wherein the machine-implemented method comprises aggregating, using a p-mean approach, the multiple element failure indices to obtain an aggregated element failure index.

Example 21 is a system, method, or apparatus including any element of any of Examples 1-20.

The above detailed description includes references to the accompanying drawings, which form a part of the detailed description. The drawings show, by way of illustration, specific examples that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The above description is intended to be illustrative, and not restrictive. For example, the above-described examples (or one or more aspects thereof) may be used in combination with each other. Other examples may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the examples should be determined with reference to the appended claims, along with the full scope of equivalents to which such claims are entitled.

1. A machine-implemented method for establishing optimized parameters defining a model of a coated structure with a lattice infill, the machine-implemented method comprising:
receiving one or more spatial boundary conditions defining constraints for the model of the coated structure;
initializing a lattice infill defined by respective lattice cells according to the one or more spatial boundary conditions;
optimizing the lattice infill and a shape of the coated structure by iteratively modifying the lattice infill and the shape of the coated structure and evaluating a strength-based criterion; and
generating, using the optimized lattice infill and the optimized shape of the coated structure with the lattice infill, a representation of the model of the coated structure with the lattice infill conforming to the one or more spatial boundary conditions.

2. The machine-implemented method of claim 1, wherein the strength-based criterion corresponds to one or more element failure indices.

3. The machine-implemented method of claim 1, wherein optimizing the lattice infill and the shape of the coated structure comprises:
assigning a material indicator variable corresponding to the shape; and
assigning a coating indicator variable corresponding to at least a coating thickness.

4. The machine-implemented method of claim 1, wherein at least one of initializing the lattice infill or optimizing the lattice infill comprises representing a geometry of the lattice infill with a characteristic parameter.

5. The machine-implemented method of claim 4, wherein optimizing the lattice infill and a shape of the coated structure comprises:
establishing a held characteristic parameter by holding constant the characteristic parameter based on the geometry of the lattice infill; and
establishing, using the held characteristic parameter, an optimized topology of the coated structure with uniform material distribution in the lattice infill.

6. The machine-implemented method of claim 4, wherein optimizing the lattice infill and a shape of the coated structure comprises:
assigning the characteristic parameter as a variable; and
establishing, using the variable, a non-uniform material distribution of the lattice infill.

7. The machine-implemented method of claim 4, creating an optimized shape of the coated structure with the lattice infill comprises:
determining, using numerical homogenization, a stiffness tensor corresponding to the characteristic parameter; and
determining, using numerical homogenization, a macroscopic effective yield stress corresponding to the characteristic parameter.

8. The machine-implemented method of claim 1, wherein the strength-based parameter corresponds to a yield criterion to define a limit of elasticity of the model of the coated structure with the lattice infill.

9. The machine-implemented method of claim 1, wherein the strength-based criterion comprises multiple element failure indices; and
wherein the machine-implemented method comprises aggregating, using a p-mean approach, the multiple element failure indices to obtain an aggregated element failure index.

10. The machine-implemented method of claim 1, wherein the lattice infill comprises octet-truss lattice cells.

11. The machine-implemented method of claim 10, wherein respective octet-truss lattice cells include a varied microstructure density.

12. The machine-implemented method of claim 1, wherein the lattice infill comprises cubic lattice cells.

13. The machine-implemented method of claim 12, wherein respective cubic lattice cells include a varied microstructure density.

14. A machine-implemented method for establishing optimized parameters defining a model of a coated structure with a lattice infill, the machine-implemented method comprising:
receiving constraints for the model of the coated structure;
initializing a lattice infill defined by respective lattice cells according to the constraints for the model of the coated structure;
optimizing the lattice infill and a shape of the coated structure by iteratively modifying the lattice infill and the shape of the coated structure and evaluating a strength-based criterion; and
generating, using the optimized lattice infill and the optimized shape of the coated structure with the lattice infill, a representation of the model of the coated structure with the lattice infill conforming to the constraints for the model of the coated structure.

15. The machine-implemented method of claim 14, wherein optimizing the lattice infill and the shape of the coated structure comprises:
assigning a material indicator variable corresponding to the shape; and
assigning a coating indicator variable corresponding to at least a coating thickness.

16. The machine-implemented method of claim 14, wherein the strength-based criterion corresponds to one or more element failure indices, and wherein at least one of initializing the lattice infill or optimizing the lattice infill comprises representing a geometry of the lattice infill with a characteristic parameter.

17. The machine-implemented method of claim 16, wherein optimizing the lattice infill and a shape of the coated structure comprises:
establishing a held characteristic parameter by holding constant the characteristic parameter based on the geometry of the lattice infill; and
establishing, using the held characteristic parameter, an optimized topology of the coated structure with uniform material distribution in the lattice infill.

18. The machine-implemented method of claim 16, wherein optimizing the lattice infill and a shape of the coated structure comprises:
assigning the characteristic parameter as a variable; and
establishing, using the variable, a non-uniform material distribution of the lattice infill.

19. The machine-implemented method of claim 16, creating an optimized shape of the coated structure with the lattice infill comprises:
obtaining, using numerical homogenization, a stiffness tensor corresponding to the characteristic parameter; and
obtaining, using numerical homogenization, a macroscopic effective yield stress corresponding to the characteristic parameter.

20. The machine-implemented method of claim 14, wherein the strength-based criterion comprises multiple element failure indices; and
wherein the machine-implemented method comprises aggregating, using a p-mean approach, the multiple element failure indices to obtain an aggregated element failure index.
